(19) United States
(12) Patent Application Publication
(10) Pub. No.: US 2008/0179421 A1
(43) Pub. Date: Jul. 31, 2008

(54) Automatic high-volume sprinker arc changer for traveler irrigators

(75) Inventors: Craig B. Nelson, Walla Walla, WA (US); Joseph D. Sinden, Walla Walla, WA (US); Rex D. Ness, College Place, WA (US)

Correspondence Address: NIXON & VANDERHYE, PC, 901 NORTH GLEBE ROAD, 11TH FLOOR, ARLINGTON, VA, 22203, US

(73) Assignee: Nelson Irrigation Corporation, Walla Walla, WA (US)

(21) Appl. No.: 12/010,681

(22) Filed: Jan. 29, 2008

Related U.S. Application Data
(60) Provisional application No. 60/897,836, filed on Jan. 29, 2007.

(51) Int. Cl. B05B 3/14; B05D 1/02

(52) U.S. Cl. 239/11; 239/225.1

(57) ABSTRACT

An adjustable sprinkler including: a sprinkler head having a bearing mounted on a support, the sprinkler head rotatable on the bearing about a vertical axis; an arc adjustment plate mounted on the support for rotation about the axis relative to the support and to the bearing; first and second stops supported on the plate for arcuate movement about the axis, at least one of the stops movable relative to the plate, wherein the first and second stops define limits of rotational movement of the sprinkler head about the axis; and a fluid actuator for moving one of the stops relative to the other of the stops for varying the limits of rotational movement of the sprinkler head.

Priority is claimed from U.S. Provisional Application Ser. No. 60/897,836, filed Jan. 29, 2007.

### BACKGROUND OF THE INVENTION

This invention generally relates to irrigation sprinklers, and more specifically, to an automatic arc adjustment device for a high-volume sprinkler.

High-volume sprinklers are often used to irrigate large fields, and they are typically attached to a hose reel stationed at one end of the field. In use, the hose is extended to its full length by means of a traveling cart with a high-volume sprinkler located on the cart. When the water supply valve is opened, water under pressure travels from the hose reel through the hose, into the cart and is dispensed through the sprinkler nozzle. As the water is applied over the area to be irrigated, the hose is slowly rolled back onto the reel, pulling the cart and the sprinkler towards the reel. When the cart and sprinkler reach the hose reel, the irrigation cycle is complete. The reel is then moved to another site where the cycle is repeated.

Where possible, and for optimum irrigation efficiency, a 270-degree arc is set for the sprinkler. This is set such that, when viewed from overhead, the 90-degree dry spot of the sprinkler is centered upon the hose being pulled towards the hose reel. This arrangement provides the best results in terms of applying water uniformly, and is the most forgiving with respect to countering the effects of wind.

Oftentimes, however, the farmer starts his cart or traveler with the sprinkler located adjacent a road, fence, or other boundary where a 270-degree arc is not feasible. Accordingly, the farmer manually sets the sprinkler pattern stops initially to provide an arc of 180 degrees, with the boundary of the area to be wetted defined by the fence, road, etc. He starts the sprinkler and operates the hose reel until the cart is pulled into the field far enough that a 270-degree operating arc will be acceptable, and then manually resets the stops on the sprinkler to provide the desired 270-degree arc. This procedure is workable, but requires the farmer or irrigator to be on site to make the required manual stop adjustments.

### BRIEF DESCRIPTION OF THE INVENTION

The exemplary but nonlimiting implementation of the invention described herein performs the above adjustment procedure automatically through the use of an electro/hydraulic device or mechanism. In the exemplary embodiment, the device is initially adjusted for the 180-degree arc at the field boundary; a timer value is input into a countdown timer attached to a solenoid valve, and the system is started. When the predetermined time value is reached, a solenoid valve is opened, extending a hydraulic cylinder piston operating on system water pressure. The extending piston causes rotation of the adjustment stops of the sprinkler to obtain the desired 270-degree arc. The arc adjustment stops always remain in the correct orientation relative to an associated tripping mechanism that reverses the direction of arcuate movement of the sprinkler head.

An advantage of the disclosed device is that it can be easily installed in the field. In addition, it is simple in construction, allowing effective trouble-shooting of any mechanical malfunction.

Accordingly, in one aspect, the invention relates to an adjustable sprinkler comprising: a sprinkler head having a bearing mounted on a support, the sprinkler head rotatable on the bearing about a vertical axis; an arc adjustment plate mounted on the support for rotation about the axis relative to the support and to the bearing; first and second stops supported on the plate for arcuate movement about the axis, at least one of the stops movable relative to the plate, wherein the first and second stops define limits of rotational movement of the sprinkler head about the axis; and an actuator for moving one of the stops relative to the other of the stops for varying the limits of rotational movement of the sprinkler head.

In another aspect, the invention relates to a sprinkler head having a bearing mounted on a support, the sprinkler head rotatable on the bearing about a vertical axis; an arc adjustment plate mounted on the support for rotation about the axis relative to the support and to the bearing; first and second stops supported on the plate for arcuate movement about the axis, the stops movable relative to the plate and to the support, wherein the first and second stops define limits of rotational movement of the sprinkler head about the axis; and means for automatically moving the arc adjustment plate and the first and second stops relative to the support to vary the limits as a function of time.

In still another aspect, the invention relates to a method of operating a sprinkler to irrigate a field having at least one end defined by a boundary and a second real or imaginary opposite end comprising: providing a sprinkler cart having a sprinkler head mounted thereon, the cart connected to a hose windable on a hose reel; locating the cart adjacent the boundary at the one end, with the hose reel located at the opposite end; setting the sprinkler head to achieve a 180-degree arc of rotation at the one end, such that water emitted from the sprinkler head does not cross the boundary; winding the hose onto the hose reel to thereby pull the cart away from the boundary at the one end in a direction toward the opposite end; and employing an actuator to automatically set the sprinkler head to achieve a 270-degree arc of rotation, with a remaining 90-degree dry area centered on the hose, when the cart is a sufficient distance away from the boundary at the one end that water emitted from the sprinkler head does not cross the boundary.

The invention will now be described in connection with the drawings identified below.

### BRIEF DESCRIPTION OF THE DRAWINGS

FIG. 1 is a schematic plan view of a cart-mounted high-volume sprinkler located at one end of a field to be irrigated;

FIG. 2 is a schematic view similar to FIG. 1, but with the cart drawn further into the field by a hose reel;

FIG. 3 is a side elevation of the high-volume sprinkler removed from the cart;

FIG. 4 is a partial enlargement of FIG. 3;

FIG. 5 is a top perspective view of the high-volume sprinkler shown in FIG. 3, with a water deflector in a first operative position;

FIG. 6 is a partial enlargement of FIG. 5;

FIG. 7 is a top perspective view similar to FIG. 5, but with the water deflector in a second operative position;

FIG. 8 is a partial enlargement of FIG. 7;

FIG. 9 is a plan view of the high-volume sprinkler, showing the automatic arc adjustment mechanism;

FIG. 10 is a plan view similar to FIG. 9, but with parts removed to show additional details of the arc adjustment mechanism;

FIG. 11 is a partial enlargement of FIG. 10;

FIG. 12 is a side elevation similar to FIG. 3 but with parts removed;

FIG. 13 is a view similar to FIG. 9, but with the sprinkler rotated clockwise through about 225 degrees;

FIG. 14 is a view similar to FIG. 13 but with parts removed; and

FIG. 15 is a partial enlargement of FIG. 14.

### DETAILED DESCRIPTION

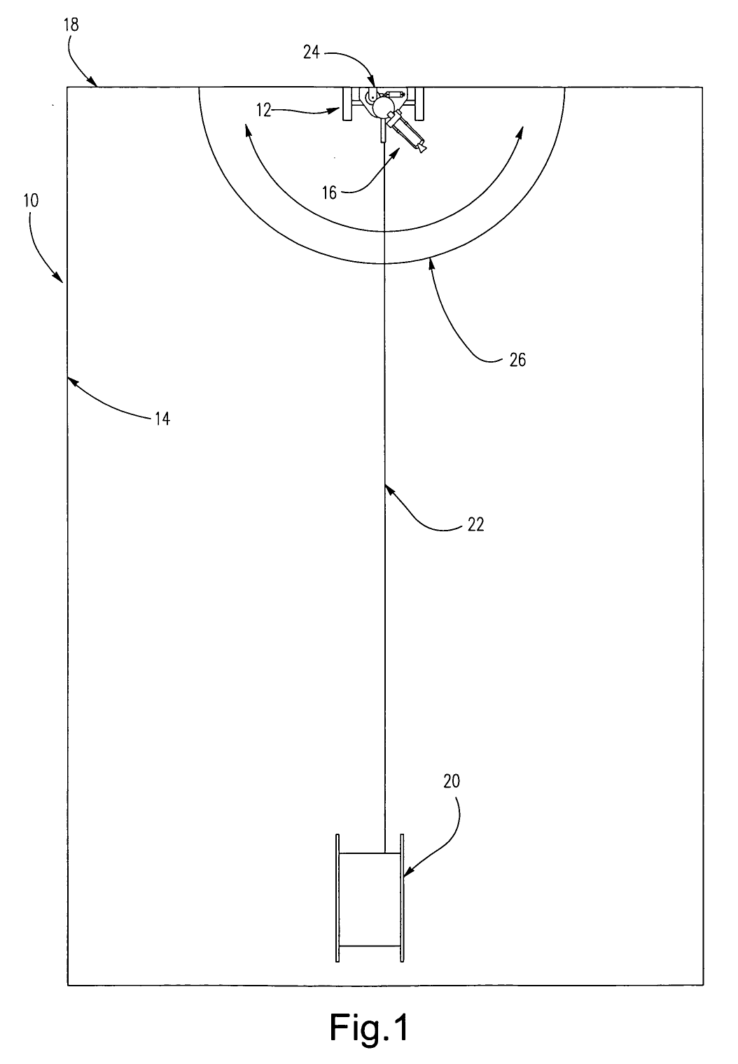

FIG. 1 shows a schematic aerial or plan view of a field 10 irrigated with a traveler cart (or, simply, “cart”) 12 at the start of the irrigation cycle. The field boundary 14 is the area to be irrigated with all water coming from a high-volume sprinkler 16, mounted on the cart, to fall within that boundary. The sprinkler 16 may be of the type available from the assignee, Nelson Irrigation Corporation of Walla Walla, Wash., known as the Big Gun® series sprinklers, or any other suitable high-volume sprinkler.

The end boundary 18 of the field is the boundary to which the cart 12 is initially pulled. A cart hose reel 20 is located at the other end of the field and is connected to the cart 12 by a hose 22 wound on the reel 20. The “other” end of the field could be a real or imaginary end depending on the length of the field vis-a-vis the length of the hose. An automatic sprinkler arc changer or adjustment mechanism 24 (sometimes referred to herein as “the arc adjustor 24”) is also located on the cart 12, at the base of the sprinkler 16. Initially, because of the presence of the end boundary 18, sprinkler pattern or arc adjustment stops (discussed in detail further below) are set to achieve a 180-degree arc 26. The sprinkler 16 thus rotates back and forth to irrigate the area described by the arc 26 and end boundary 18.

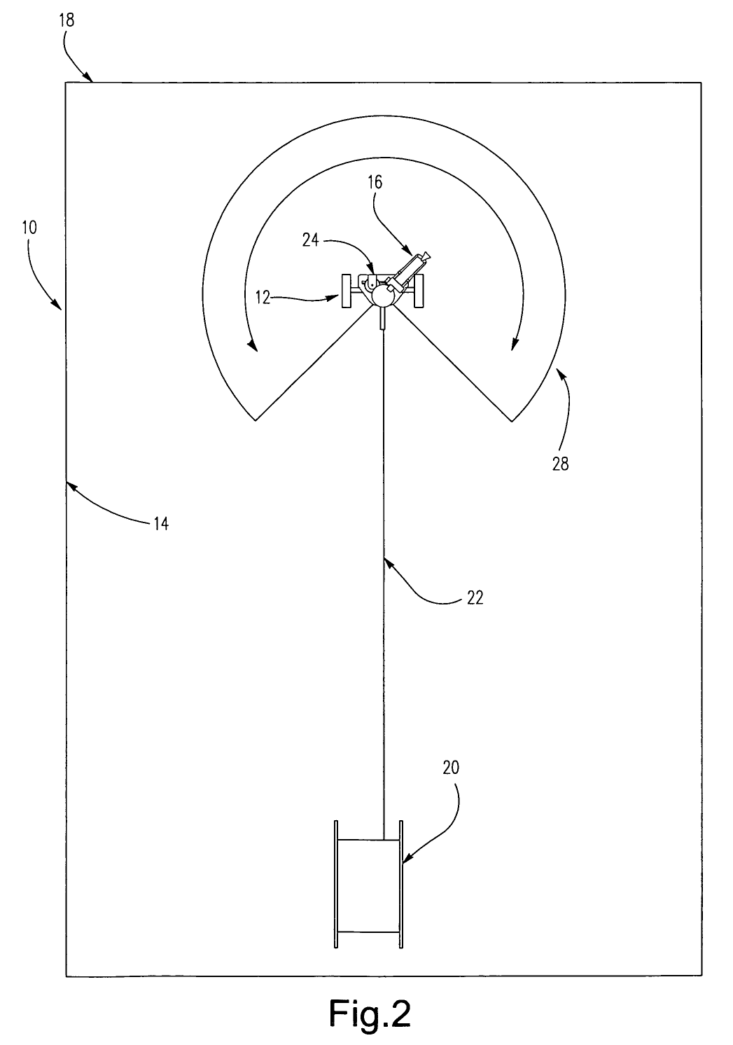

FIG. 2 shows a schematic aerial view of the same irrigated field 10 as in FIG. 1 but after the cart hose 22 has been wound onto the hose reel 20, pulling the cart 12 away from the end boundary 18 to a point where a 270-degree operating arc 28 can be safely run without the sprinkler stream extending beyond or outside the end boundary. It is the arc adjustor 24 described in further detail below that implements the arc change from 180 degrees to 270 degrees.

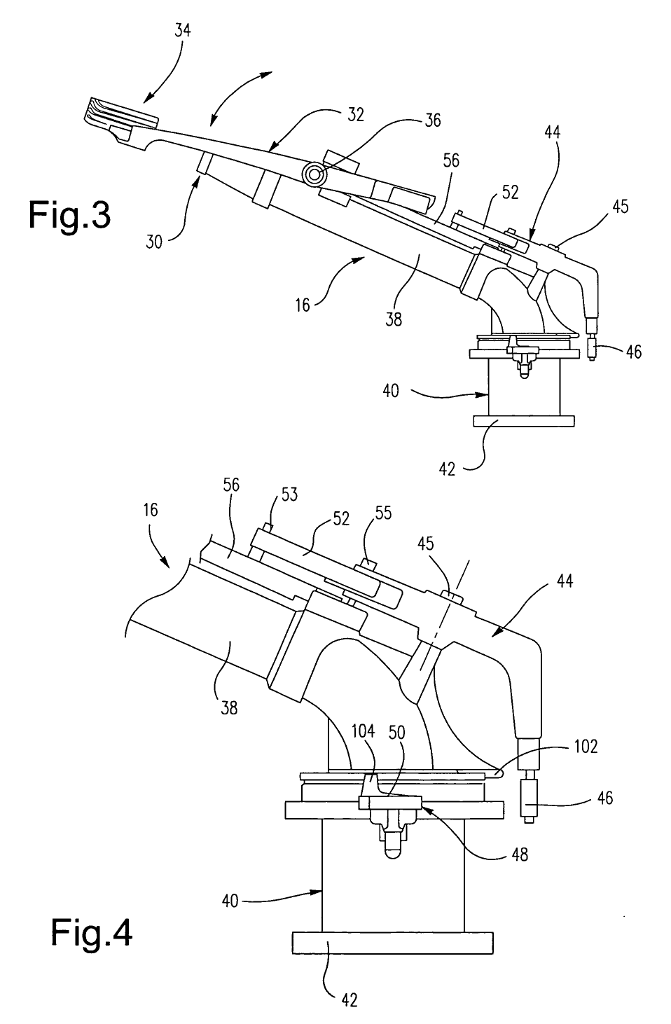

FIG. 3 is a side view of the high-volume sprinkler 16. The sprinkler 16 rotates under the power of the water exiting the sprinkler nozzle 30. Specifically, a drive arm 32 moves up and down as water strikes a drive vane 34 fixed to a remote end of the arm. The drive arm 32 is constructed such that the water, as it leaves the drive vane, causes the drive arm to pivot about a horizontal axis defined by drive arm shaft 36 fixed to the sprinkler body 38. The sprinkler body 38, and hence nozzle 30, also rotate about a vertical axis in the form of a lower bearing unit (or simply lower bearing) 40, which, in turn, is mounted to the cart 12 via a mounting flange 42.

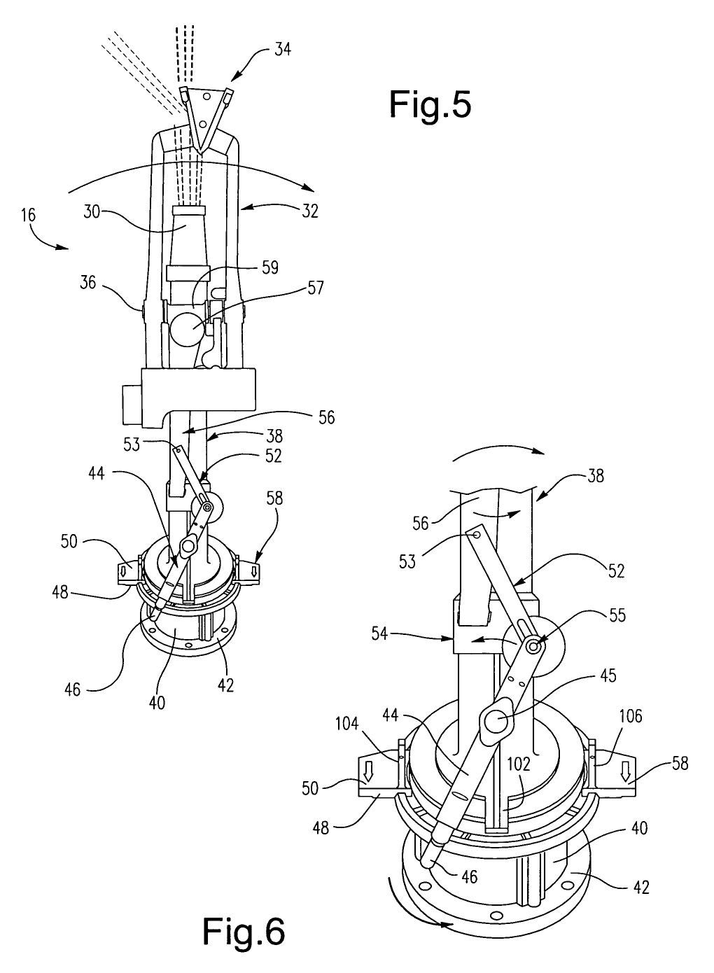

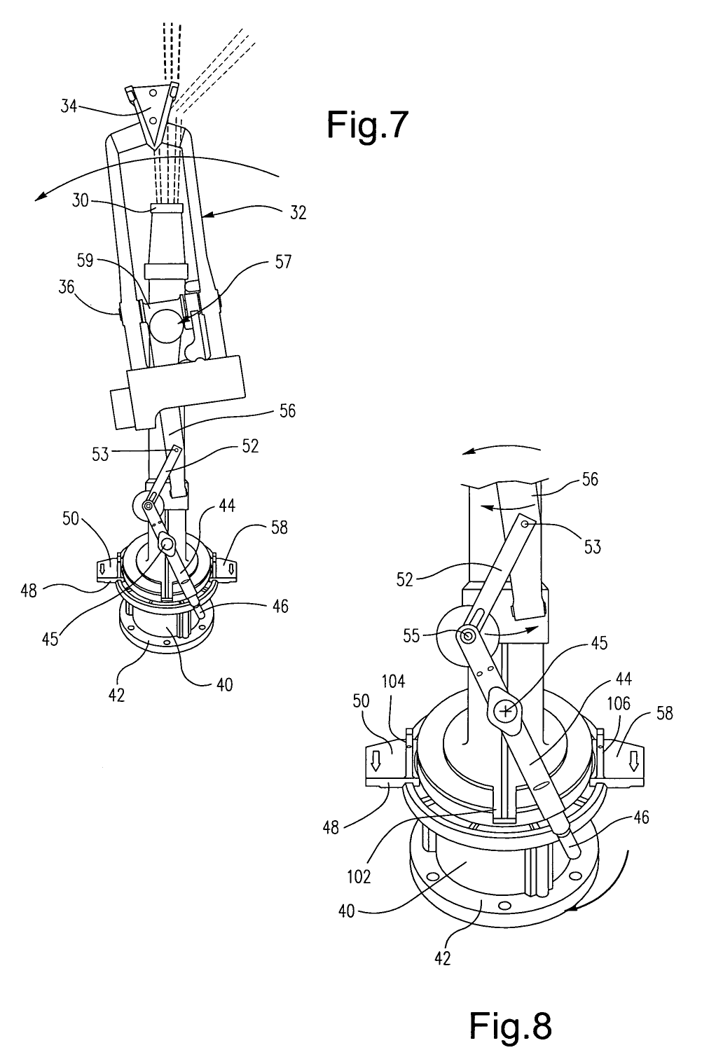

FIG. 4 is a close-up of the lower bearing unit 40, showing a trip lever 44 and associated arc adjustment components of the sprinkler 16 described further herein. FIGS. 5-8 illustrate reversal of direction sequence of the sprinkler. For ease of understanding, the description of the structure of the various arc adjustment components is tied to their function in use. As already noted, as the water exits the nozzle 30 at pressure, the drive arm 32 swings upwardly about the shaft 36 and contacts the water stream, a portion of which is deflected (see FIG. 5) by the drive vane 34 causing the sprinkler to rotate in a clockwise direction about the lower bearing 40. The trip lever 44 is mounted to the sprinkler body 38 and thus rotates with the sprinkler body, but the lever is also free to pivot about the rod or pin 45 (which forms a pivot axis for the lever) on which it is seated. As the sprinkler rotates in the clockwise direction, a trip lever roller 46 mounted to the lower end of the lever 44 will contact a trip face 48 of a clockwise stop 50. The water will continue driving the sprinkler in a clockwise direction causing the trip lever 44 to rotate about the trip lever pivoting axis 45 in a counterclockwise direction. At an over-center point, an over-center “spring” 52 pivotally attached to a shift lever 56 via pin 53, as well as to the trip lever 44 via pin 55, will shift to the other side of a stop bracket 54 (compare FIGS. 6 and 7), rotating the shift lever 56 in a counterclockwise direction about a shift lever pivot axis or bushing 57 that is integrated with a bushing 59 that receives the drive arm shaft 36. Thus, the counterclockwise rotation of the shift lever also causes counterclockwise rotation of the drive arm (compare FIGS. 5 and 7). Now the water stream impinges on the other side of the vane 34, causing the sprinkler 16 to rotate in a counterclockwise direction as shown in FIG. 7 until the trip lever roller 46 contacts a counterclockwise stop 58, reversing the sprinkler direction through reverse action of the components as described above. The direction-reversal mechanism per se as described above is known in the art.

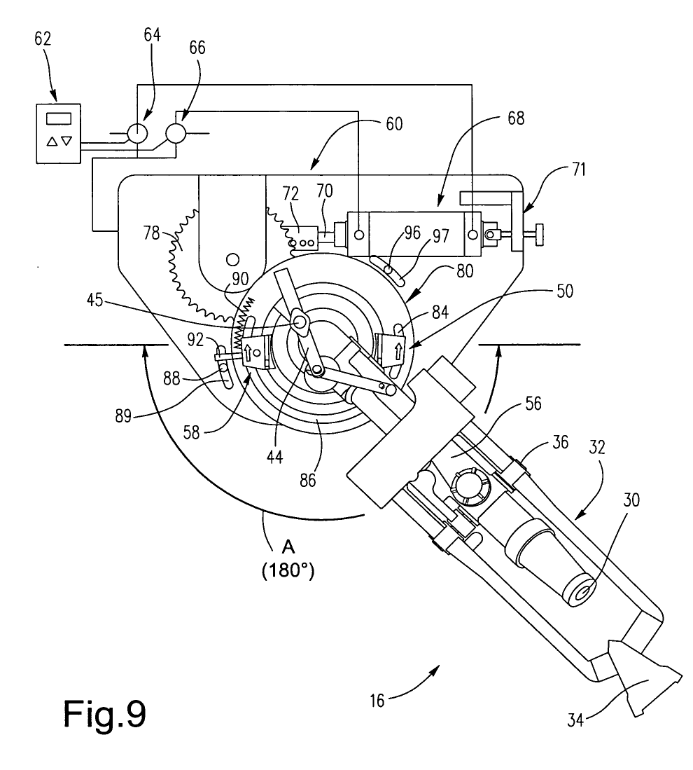

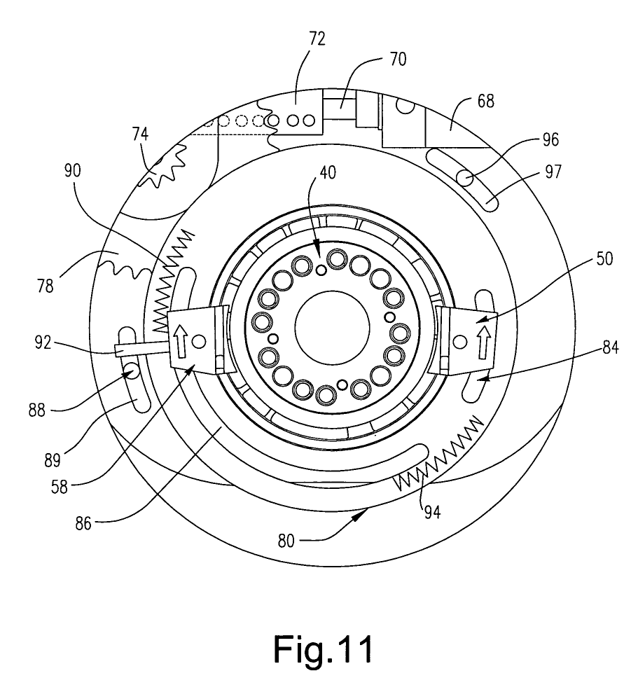

With reference now to FIGS. 9-12 (but with continuing reference to FIGS. 5-8), the pattern or arc adjustment stops 50 and 58 are positioned in FIGS. 8-11 to provide a 180-degree arc of coverage about an arc “A” (FIG. 9). The arc adjustment mechanism includes a base plate 60 secured to the lower end of the sprinkler, e.g., to the mounting flange 42. A countdown timer 62 is electrically connected to two latching, three-way solenoids 64 and 66. The electrical components 62, 64 and 66 may be mounted on the base plate 60 or on any convenient support on the sprinkler cart 12. As shown, solenoid 64 is normally open and effects the 180-degree arc, while solenoid 66, normally closed, is used to effect the 270-degree arc. The solenoids are connected to a double-acting cylinder 68, also mounted on the base plate 60. As explained in greater detail below, in “position one” (for a 180-degree arc) the cylinder piston 70 is retracted, and in “position two” (for a 270 degree arc) the cylinder piston 70 is extended. The cylinder 68 is mounted to the base plate 60 by a cylinder mounting bracket 71, or any other suitable securement mechanism.

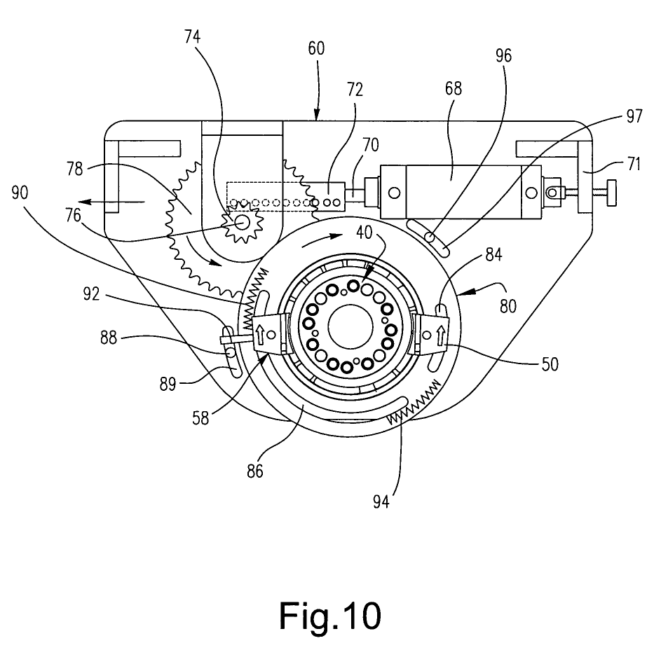

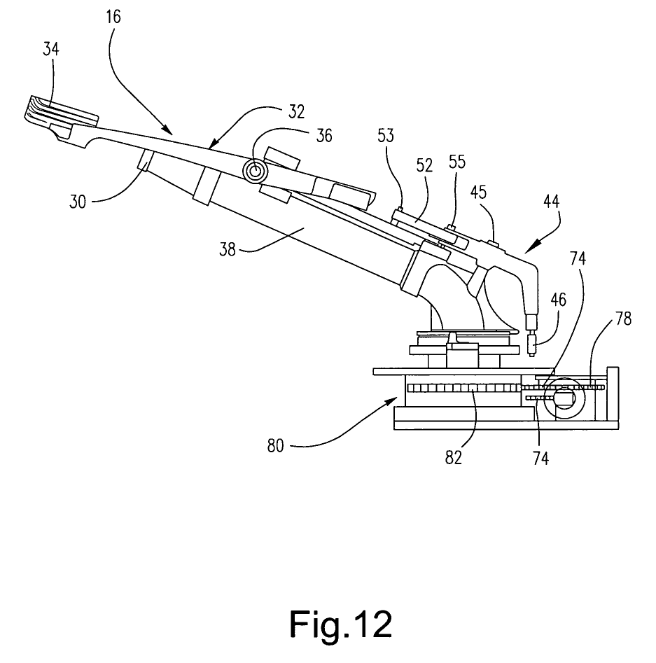

The piston 70 of the cylinder 68 is attached to a linearly movable rack 72 which drives a drive gear 74 (FIG. 10) about a shaft (or axis) 76 secured to the base plate 60. The drive gear 74 is attached to a larger diameter multiplier gear 78, also secured to the base plate. This gear assembly, when driven, rotates an arc adjustment plate/gear housing 80 (also referred to herein as the “arc adjustment plate”, or, simply, “the plate”) via engagement with a gear component 82 of the housing 80, best seen in FIG. 12, and as described in further detail below.

As best seen in FIGS. 9 and 10, the clockwise stop 50 is fixed in the clockwise stop adjustment groove 84 formed in the plate 80. This groove, extending only about 45 degrees, allows for fine field adjustment of the clockwise sprinkler rotation for the initial 180-degree operation. The counterclockwise stop 58 floats in the counterclockwise stop adjustment groove 86, also formed in the plate 80, and is free to move around the centerline axis of the arc adjustment plate, as permitted by the groove 86, and as limited by external stop posts described below. Thus, the stop 58 is constrained by a first stop post 88 for 180-degree movement (post 88 is adjustably attached to the base plate 60 via groove 89), and a 180-degree stop spring 90 which is attached to the arc adjustment plate 80. In this regard, a stop pin 92 projects from the stop 58 such that it will engage the stop post 88 during counterclockwise rotation of the plate 80 (i.e., when the arc is reset to 180 degrees from 270 degrees), and is then held against the post by the counterclockwise compression spring 90.

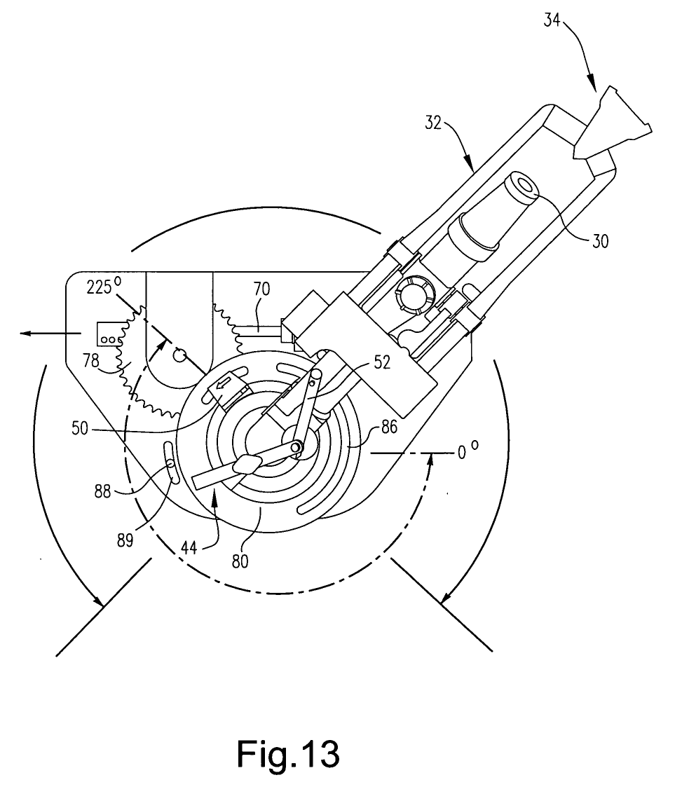

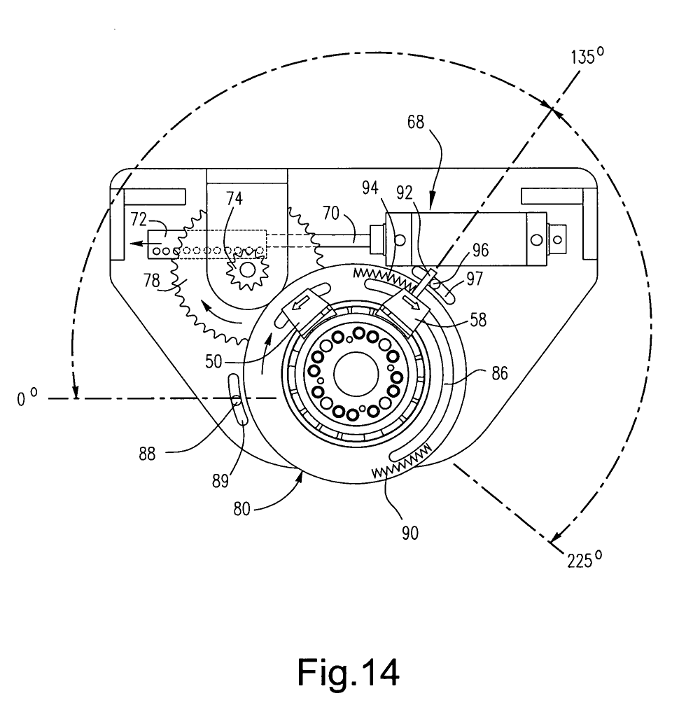

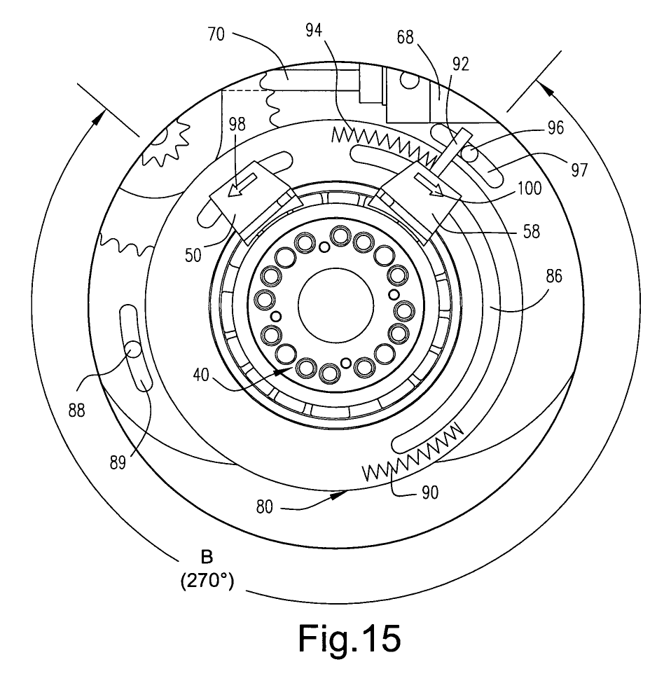

After a time value entered in the timer 62 has expired, the solenoid 66 will open, causing the piston 70 to move from retracted position one to extended position two as shown in FIG. 13. During extension of the piston 70, the rack 72 rotates the drive gear 74 and multiplier gear 78 which, in turn, rotates the plate 80 via gear component 82 (seen more clearly in FIG. 12, and which could be in the form of a simple chain wrapped about the lower housing portion of the plate 80) through 225 degrees, thus placing the stops 50 and 58 in their final positions for 270 degrees of sprinkler rotation. More specifically, and with additional reference to FIGS. 14 and 15, as the arc adjustment plate 80 rotates from its FIG. 9 position, i.e., position one, the counterclockwise stop 58 also rotates through approximately 135 degrees until the stop pin 92 contacts a second stop post 96. Post 96 is also adjustable within a groove 97 and is attached to the base plate 60. The post 96 “holds” the clockwise stop 58 in this rotational location while the plate 80 continues to rotate. The counterclockwise stop 58 thus “floats” in the counterclockwise stop adjustment groove 86 as the arc adjustment plate 80 continues its rotation through the full 225 degrees. The clockwise rotation of the plate 80 ends with full extension of the piston 70, prior to when the stop 58 would otherwise be engaged by the end of the groove 86. Note that the groove 86 may itself extend about 160 degrees, with two adjustable rubber (or similar) stops attached to plate 80 and located within the grove 86, thus defining the rotation limits of the stop 58 relative to the plate 80. These rubber or similar stops simply serve to protect the plate by preventing engagement of the stop with the ends of the groove 86.

Note that the stop pin 92 will be pressed against the post 96 by the clockwise compression spring 94 as the plate 80 and spring 90 continue rotation relative to the now stationary stop 58 and pin 92. At the same time, stop 50 has also been rotated to the position shown in FIG. 14, so that the sprinkler is now rotatable through a 270-degree arc “B” (FIG. 15), generally between the arrowheads 98, 100 on the stops 50, 58, respectively. While the springs 90 and 94 are arranged to compress upon engagement of pin 92 with posts 88 or 96 (and thus push the pin 92 against the posts 88 and 96), depending on the direction of rotation of the plate 80, it will be appreciated that similar springs could be relocated to extend in tension so as to pull the pin 92 into engagement with posts 88 and 96 without departing from the scope of this invention.

As noted above, rotation of the arc adjustment plate 80 is initiated by the timer 62 and associated solenoids 64, 66 that control movement of the piston 70 between retracted and extended positions. The timer 62 is set to cause the piston to extend when the set time period has expired. The time value input to the timer 62 is based on field conditions and cart movement such that sufficient time is allotted to allow the sprinkler cart to move a distance away from the end boundary 18 which will permit a 270-degree arc of coverage that does not project beyond the end boundary 18 behind the sprinkler (see FIGS. 1 and 2).

In a subsequent cycle, retraction of the piston 70 will rotate the plate 80, along with stops 50 and 58 to the first position shown in FIGS. 9-11 for a 180-degree pattern.

Note that a projection 102 on the sprinkler head will engage upstanding tabs 104, 106, on the stops 50, 58, respectively, insuring that the sprinkler head rotation is confined to arcuate movement between the stops 50 and 58. It should also be noted that adjustment of the stops 50 and 58 does no harm to the direction reversal mechanism. The sprinkler head necessarily rotates during the change from a 180-degree arc to a 270-degree arc, such that the trip lever will be engaged by the stop 50 and will cause the over-center spring 52 to shift as described above in connection with FIGS. 6 and 7. Absent water under pressure flowing through the sprinkler head, this shift is of no consequence.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. An adjustable sprinkler comprising:
a sprinkler head having a bearing mounted on a support, said sprinkler head rotatable on said bearing about a vertical axis;
an arc adjustment plate mounted on said support for rotation about said axis relative to said support and to said bearing;
first and second stops supported on said plate for arcuate movement about said axis, at least one of said stops movable relative to said plate, wherein said first and second stops define limits of rotational movement of said sprinkler head about said axis; and
an actuator for moving said one of said stops relative to the other of said stops for varying said limits of rotational movement of said sprinkler head.

2. The adjustable sprinkler of claim 1 including means for reversing the direction of rotation of said sprinkler head within the limits set by said first and second stops.

3. The adjustable sprinkler of claim 1 wherein said actuator comprises a hydraulic cylinder and piston operatively connected between said support and said arc adjustment plate.

4. The adjustable sprinkler of claim 3 wherein said piston is connected to a linearly movable rack that engages a drive gear.

5. The adjustable sprinkler of claim 4 wherein said drive gear engages a larger multiplier gear which, in turn, engages a gear component on a housing portion of said arc adjustment plate.

6. The adjustable sprinkler of claim 3 wherein said piston is actuated by at least one timer-controlled solenoid.

7. The adjustable sprinkler of claim 1 wherein said at least one of said stops is movable within a first arcuate groove formed in said arc adjustment plate, said first arcuate groove extending about 160 degrees.

8. The adjustable sprinkler of claim 7 wherein the other of said first and second stops is adjustable within a second arcuate groove formed in said arc adjustment plate, said second arcuate groove extending about 45 degrees.

9. The adjustable sprinkler of claim 8 wherein arcuate movement of said at least one stop is limited by a pair of circumferentially spaced posts fixed on said support, said at least one stop provided with a pin for selectively engaging said posts.

10. The adjustable sprinkler of claim 9 wherein each of said posts is adjustable relative to said support.

11. The adjustable sprinkler of claim 9 wherein plural springs are attached to said plate and are adapted to selectively maintain engagement between said pin and said posts.

12. The adjustable sprinkler of claim 11 wherein said first and second stops are adjustable via said actuator to establish at least 180-degree and 270-degree arcs of rotation by said sprinkler head.

13. The adjustable sprinkler of claim 1 wherein said sprinkler head is mounted on a cart connected to a hose that is windable on a hose reel.

14. The adjustable sprinkler of claim 2 wherein said means is operable to reverse the direction of said sprinkler head through engagement of a trip lever with said first and second stops.

15. The sprinkler of claim 12 wherein said plate is rotatable through about 225 degrees to move said first and second stops to final positions establishing said 270-degree arc of rotation, said plate continuing to rotate beyond a position where said at least one stop reaches said final position.

16. An adjustable sprinkler comprising:
a sprinkler head having a bearing mounted on a support, said sprinkler head rotatable on said bearing about a vertical axis;
an arc adjustment plate mounted on said support for rotation about said axis relative to said support and to said bearing;
first and second stops supported on said plate for arcuate movement about said axis, said stops movable relative to said plate and to said support, wherein said first and second stops define limits of rotational movement of said sprinkler head about said axis; and
means for automatically moving said arc adjustment plate and said first and second stops relative to said support to vary said limits as a function of time.

17. The sprinkler of claim 16 wherein said stops are movable to establish at least 180-degree and 270-degree arcs of rotation for said sprinkler head.

18. The sprinkler head of claim 16 wherein said sprinkler head is mounted on a cart connected to a hose that is windable on a hose reel.

19. A method of operating a sprinkler to irrigate a field having at least one end defined by a boundary and a second real or imaginary opposite end comprising:
providing a sprinkler cart having a sprinkler head mounted thereon, the cart connected to a hose windable on a hose reel;
locating the cart adjacent said boundary at said one end, with said hose reel located at said opposite end;
setting said sprinkler head to achieve a 180-degree arc of rotation at said one end, such that water emitted from the sprinkler head does not cross said boundary;
winding said hose onto said hose reel to thereby pull said cart away from said boundary at said one end in a direction toward said opposite end; and
employing an actuator to automatically set said sprinkler head to achieve a 270-degree arc of rotation, with a remaining 90-degree dry area centered on said hose, when said cart is a sufficient distance away from said boundary at said one end that water emitted from said sprinkler head does not cross said boundary.

20. The method of claim 19 including providing a mechanical trip mechanism to automatically reverse the direction of rotation of the sprinkler head at the limits of selected arcs of rotation.
